(19) United States
(12) Patent Application Publication
(10) Pub. No.: US 2006/0205508 A1
(43) Pub. Date: Sep. 14, 2006

(54) On-line table gaming with physical game objects

(75) Inventor: Darryl Green, Toronto (CA)

Correspondence Address: PATENT LAW GROUP LLP, 2635 NORTH FIRST STREET, SUITE 223, SAN JOSE, CA, 95134, US

(73) Assignee: Original Deal, Inc.

(21) Appl. No.: 11/080,690

(22) Filed: Mar. 14, 2005

(51) Int. Cl. A63F 13/00

(52) U.S. Cl. 463/40

(57) ABSTRACT

A technique is described where on-line players may participate in a table game involving physical elements such as a gaming table, players at the table, dealers, croupiers, betting chips, cards, dice, a roulette wheel, etc. The on-line players thus will have a more realistic experience than in a pure on-line system with all virtual elements. Electronic sensors in the table, or other detectors, sense the dealt cards and bets, and the data is communicated to the remote players. The remote players enter commands via a network (e.g., the Internet), and those commands are carried out at the physical table by the dealer placing bets for the player, dealing cards, or any other action. At the end of the session, the on-line players' accounts are debited or credited. If the on-line players are playing with physical betting chips, the on-line players' bet/won chips are appropriately distributed by the dealer to the player positions at the table. The players physically at the table play in a normal manner.

### FIELD OF THE INVENTION

This invention relates to table gaming, such as poker, craps, roulette, etc., and in particular to combining physical play with on-line play of the game.

### BACKGROUND

On-line table gaming via the Internet, wireless networks, interactive television, and private networks is very popular. In one example, an on-line player sees on his computer monitor a virtual table and his virtual dealt cards. Other on-line players see their own cards displayed. All dealing is performed by a remote application server running a program where a pseudo-random number generator (RNG) deals virtual cards to the players. The on-line players bet via a touch screen, a keyboard, or a mouse, and the game is conducted by the application server using conventional rules. At the end of the hand, the result is determined, and the players' accounts are debited and credited based on the results.

### SUMMARY

A technique is described herein where on-line players may participate in an actual table game involving physical elements such as a gaming table, players at the table, dealers, croupiers, betting chips, cards, dice, a roulette wheel, etc. The on-line players thus will have a more realistic experience than in a pure on-line system with all virtual elements.

In one example of a poker game, the table is set up for both present players and on-line players. The on-line players may be connected via a local network, the Internet, a wireless network, interactive television, a private network, a virtual private network, or any other suitable system. The cards are encoded with bar codes, Radio Frequency Identification (RFID) devices, other electronic circuits, or any other type of encoder identifying the cards' identities. In another embodiment, card image recognition is used to identify the cards. If an automatic shuffler is used that already identifies the cards prior to being dealt, the table need not be specially configured for identifying the cards.

The identifications of the dealt cards are communicated to the appropriate on-line players. The on-line players may view the play with a computer-generated image of the table or an actual video image of the table. Bets are detected by any electronic means such as by RFID devices embedded in the chips. The on-line players make commands to bet, draw cards, etc. via a touch screen, a keyboard, a mouse, or voice (e.g., using VoIP). A monitor, display, speaker, or other means at the gaming table may be used to communicate the on-line players' commands to the dealer or to other players. If appropriate under the circumstances, the dealer may carry out the command by, for example, moving the on-line players' chips into the betting area or dealing cards.

At the end of the game, the on-line players' bet chips are distributed to the winning player, or the on-line players' accounts are debited or credited. The players physically at the table, if any, play in a normal manner.

Accordingly, the conventional RNG for on-line gaming is replaced by a dealer or a physical automatic card shuffler, and the on-line players may play along with players at the table using conventional physical elements (e.g., cards, chips) for playing the game. Any type of table game may be played.

The inventive system allows the technology to plug into any existing gaming infrastructure (e.g., a conventional on-line card game system) through an application interface (specifies the I/O interface only), where such gaming infrastructures can now offer the players the choice of existing RNG play or human dealer play. In other words, the software code and data to implement the invention can easily be introduced into exiting gaming infrastructures.

### BRIEF DESCRIPTION OF THE DRAWINGS

FIG. 1 illustrates one example of a physical gaming table, with players, if any, physically at the table and remote on-line players playing the same game. FIG. 1 also illustrates certain functional units for sensing cards and chips and for communicating between the on-line players and the people at the table.

FIG. 2 illustrates an encoded playing card with a barcode, an RFID device, or other electronic device.

FIG. 3 illustrates an encoded betting chip with a barcode, an embedded RFID device, or other electronic device.

FIG. 4 illustrates one example of a gaming table with sensor areas for detecting cards and bet chips.

FIG. 5 is a functional block diagram of a detection system using RFID devices.

FIG. 6 is a flowchart describing one method for carrying out a game using the systems of FIGS. 1 and 4.

### DETAILED DESCRIPTION

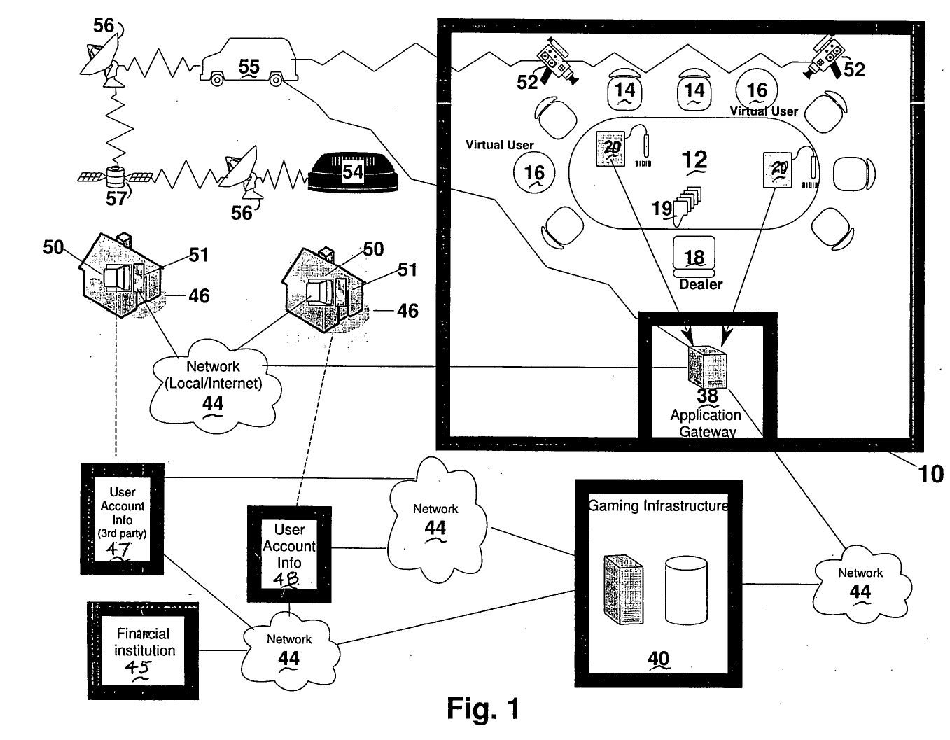

FIG. 1 illustrates a room 10 in a casino, a studio, or other facility housing a physical gaming table 12. It is assumed that the game being played is Hold'em Poker, although any table game may be played such as blackjack, craps, or roulette.

Stools 14 are around the table 12 for the players, if any, present at the table. Certain stools 16 are at positions taken by on-line players. Any position can be taken by an on-line player. In the example of FIG. 1, up to nine players may play at one time. A dealer sits on a dealer's stool 18 or stands in that position. The dealer deals from a card dealing shoe 19, which may be an automatic shuffler or combination of the foregoing and a card reader that determines the card prior to being dealt.

A sensor 20 is located under, in, or on top of the table 12 at some or all of the player positions. Sensors 20 at only two positions are shown for simplicity. The sensor 20 may be a barcode reader, an RFID reader (including a short range antenna), a camera for image recognition of the cards, or any other suitable sensor for detecting the dealt cards' identities. Each sensor 20, or other sensor in the table, also identifies the encoded chips bet by the players when the bet chips are moved into the sensor area.

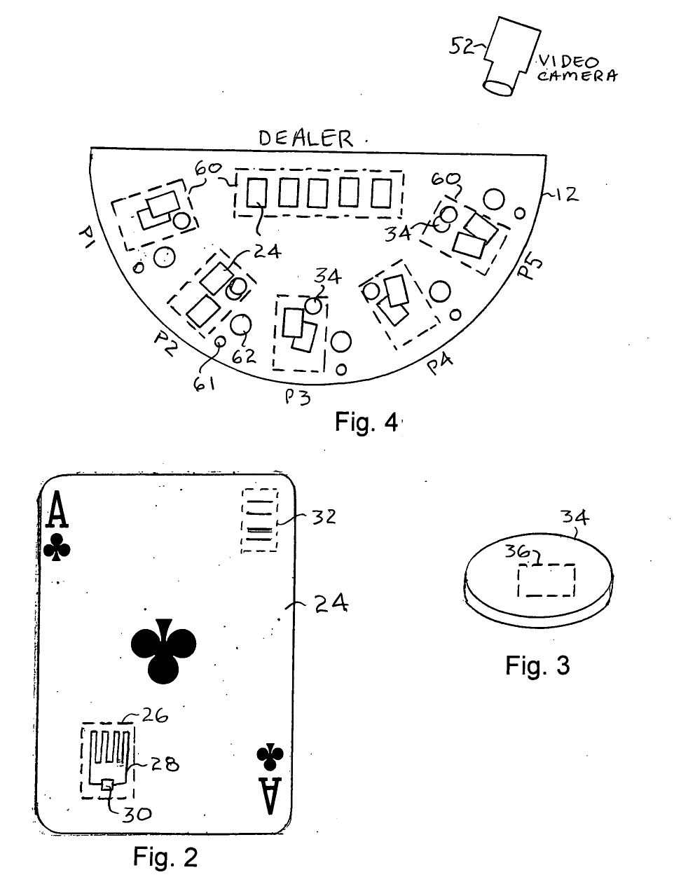

FIG. 2 illustrates a playing card 24 with an embedded RFID device 26 between the plies. The RFID device 26 includes an antenna 28 that receives a signal from an RFID reader under the table 12 and provides power and information to the silicon chip 30. The chip 30 has a programmed memory that outputs a digital code corresponding to the identity of the card. Alternatively, the card 24 may have printed on it a barcode 32 identifying the card. If an automatic shuffler or card reading device is used that identifies the card dealt to each player, additional card sensors will typically not be needed, but may be used for backup for verification purposes.

FIG. 3 illustrates a betting chip 34 with either an RFID device 36 embedded in it or a barcode. Alternatively, sensor 20 in FIG. 1 may include a sensitive scale that registers the weight of the bet chips. Each chip has a weight related to its value. For example, a $5 chip may weigh five times as much as a $1 chip. In a more complex system, a $10 chip, for example, may have a weight of 1.1 times a $1 chip. Any bet with nine or fewer $10 chips can be uniquely detected by the weight of the chips. Higher bets may use $50 or higher denomination chips with different weights.

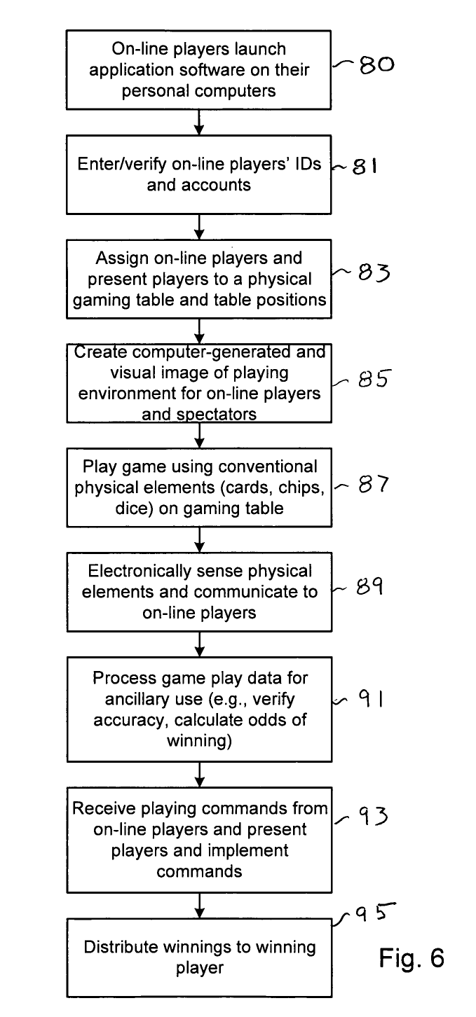

Referring back to FIG. 1, an application gateway server 38 receives the sensed signals from the physical objects on the table, carries out the application functions, and transmits the data to the on-line players, described in more detail with respect to the flowchart of FIG. 6. The communication paths are two ways, allowing the on-line players to communicate with the dealer or players at the table. The applications gateway server 38 may just perform the processing that differs from a conventional gaming infrastructure (e.g., a conventional, previously existing on-line gaming network with all virtual cards, etc.). In that way, the conventional gaming infrastructure does not have to be recreated, but can just be augmented to allow the on-line players to have a choice of playing a standard virtual game with a RNG or an actual game with real cards and a dealer. The new application can just “plug into” the existing gaming infrastructure through an application interface (API), where the new application is modular and just “plugs into” the gaming infrastructure. Such API software techniques are well known.

A gaming infrastructure server 40 communicates with the application gateway server 38 and with other systems via any type of network 44. The gaming infrastructure server 40 performs additional processing required to carry out the game based on the game logic that is incorporated therein, depending on what actions are already carried out by the application gateway server 38. The gaming infrastructure server 40 may handle the account debiting and crediting, create computer-generated images of cards and the table for the on-line players, process the various players' commands for display on the computer-generated image, and any other desired function. As previously mentioned, the software for the gaming infrastructure server 40 may largely already exist, since the new functions involved in the present invention are primarily performed by the application gateway server 38. Communications by the various servers may be encrypted for added security. The gaming infrastructure server 40 may communicate with a financial institution 45, the casino cashier, or any other system (e.g., an existing on-line gaming database) for obtaining data. Data sources 47 and 48 are shown for obtaining user account information.

The network 44 may be any a conventional network, such as the Internet, a LAN, a WAN, a VPN, or any other network. The on-line players may be playing from their homes 46, from their hotel rooms, from a studio, or from any other location. A monitor 50 and computer/keyboard 51 are shown in the home 46. The monitor 50 may include a touch screen interface for entering player commands.

Video cameras 52 view the table 12 for recording the game for verification purposes or for televising the game for spectators. A top down image of a TV 54 is shown. The electronic and/or video detection of the dealt cards may be used to calculate the odds of a player winning. The odds are then displayed to the spectators. A communications equipment truck 55, various transponders 56, and a satellite 57 are shown.

FIG. 4 illustrates in greater detail the possible sensor areas 60 (in dashed outline) at each player position P1-P5 and dealer position. Cards 24 and bet chips 34 are shown being sensed in the sensor areas 60. The particular game being played is Hold'em Poker with each player being dealt two down cards and five up common cards being ultimately dealt in front of the dealer. Since it may be desirable to electronically detect the cards dealt face up, RFID devices rather than barcodes on the cards are preferable, unless an automatic shuffler with card detection is used.

If an automatic shuffler with card detection technology is used that identifies the cards dealt to the players and the common cards, there would be no need to further sense the cards, unless for verification and back up purposes. In another example, a video camera under the table captures the identities of face down cards, and the images are either mapped to the cards' identities or a human operator manually identifies the cards via an input device.

The table 12 may also be equipped with a microphone 61 and speaker 62 or headset at each player position so the on-line players may verbally interact with the players and dealer at the table. A monitor at the table may instead display the on-line players' commands or questions.

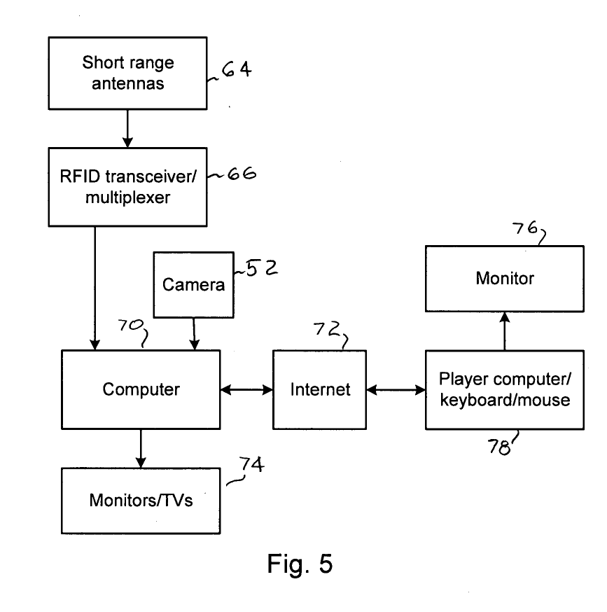

FIG. 5 is a functional block diagram of one possible system for sensing the identifications of cards and betting chips. Under each sensor area 60 in FIG. 4 is a short range antenna 64 for sensing the RFID devices in the cards and chips only within a sensor area 60. An RFID transceiver 66 communicates with each antenna 64 via a multiplexer. Alternatively, each sensor area 60 is associated with its own RFID transceiver. The sensed cards/chips are assigned by the system to the appropriate player or player position by, for example, applying a player-specific digital tag to the sensed data. Each state of the RFID multiplexer corresponds to a player position, and that state may serve as the digital tag.

The card IDs, chip IDs, and player-specific tags are processed by a computer 70 (e.g., an application server) for routing to the appropriate on-line players via the Internet 72 and to any other destination (e.g., a remote monitor 74 or TV). The video feed from the video camera 52 is also processed and routed to the appropriate destinations. The on-line players view the game on conventional computer monitors 76 and enter commands via the player's keyboard or mouse 78 or by voice. An on-line player may speak into a microphone connected to his computer, and a speaker at that player's table position allows the player's voice to be heard by the other players and dealer. The monitors 74 may also include a monitor at the table for visually identifying the players' commands.

FIG. 6 is a flowchart of one method performed using the system described above. The steps need not necessarily occur in the order listed. Not every step is required for the invention.

In step 80, the on-line players start up an applications program on their personal computers that allows the on-line players to log in and interact with the people at the table, if any.

In step 81, the on-line players' IDs and account information are entered (e.g., using a keyboard) and verified via an internal or external network. The account may be a deposit or credit account with the casino or a bank.

In step 83, the game table and table positions of the on-line players and present players are entered so the sensed cards, bets, winnings, etc. can be allocated to the proper players.

In step 85, a computer-generated image of the table (or preexisting software client application representing the table) and, optionally, a visual image (by camera 52) are created for the on-line players and spectators. The computer-generated image of the table (or preexisting software client application representing the table) may be similar to the conventional table image in existing on-line gaming programs where the table actions (e.g., cards dealt, bets made, etc.) are simulated images.

In step 87, the game is initiated, with antes being placed using actual chips, cards being dealt, etc. Cards may be shuffled by an automatic shuffler or a dealer. In a card game, the dealer deals actual cards to each player position for sensing within a sensor area 60 (FIG. 4). If an automatic shuffler were used that sensed the identities of cards during shuffling, there would be no need for a sensor area 60 to detect the cards; the identities of the cards would be directly communicated to the application gateway server along with a player identifier.

The dealer may move the on-line players' bet chips to the sensor areas 60 on the table when commanded. Alternatively, an on-line player's bets are displayed by a display device at the on-line player's position or at another location, and the on-line player does not bet with physical chips.

If the game were other than a card game, such as craps or roulette, the dice would be rolled or the roulette wheel would be spun. The outcome would be electronically communicated to the on-line players. For craps, the table may have an under-table camera that detects the image of the dice facing the table. The image is then mapped to the dice values on the top side of the dice, and those values are communicated to the on-line players. For roulette, each roulette wheel position may have a sensor that detects if the ball is in that position. The outcome may alternatively be communicated by the croupier using a touch screen or other device.

In step 89, the dealt cards and bets are electronically sensed and transmitted to the appropriate on-line players for evaluation.

In step 91, which may occur during or before step 89, the sensed data is further processed to, for example, verify accuracy (e.g., detect duplicate cards), encrypt data, generate odds of a player winning for display to spectators, or record the data for verification purposes.

In step 93, the game is carried out to completion. The sensed cards and other aspects of the game are communicated to the on-line players. The players at the table and the on-line players make bets, and the dealer deals additional cards as required. The on-line players enter commands by a touch screen, mouse, keyboard, or voice.

In step 95, the game is completed, and the pot is distributed to the winning player. If an on-line player is playing with actual chips at the table and wins, the won chips are stacked by the dealer at the player's position. If the on-line player is playing with virtual chips and wins, the won chips are credited to the player. If an on-line player cashes out, the on-line player's account is credited with his winnings.

Multiple tables may be set up with any combination of on-line and present players, including no present players.

All technology described herein is readily available. The software programs used to carry out the invention may be easily developed by those skilled in the art.

The concept of allowing remote players to play actual gaming table games may be applied to any game including chance and skill based games.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method for carrying out a table game comprising:
providing a playing area for carrying out a game;
providing at least a first player position at the playing area for a remote player communicating via an electronic communications network, the playing area having multiple player positions for accommodating multiple players;
dealing physical playing cards to the multiple playing positions;
electronically sensing the identities of cards dealt to at least the first player;
electronically communicating to the first player the identities of the cards dealt to the first player;
electronically communicating to the first player any bets made during the game;
receiving commands from the first player regarding playing the game;
determining an outcome of the game; and
distributing winnings to a winning player.

2. The method of claim 1 wherein the cards have a barcode printed thereon, and wherein electronically sensing the identities of cards comprises sensing the identities of cards with a barcode scanner.

3. The method of claim 1 wherein the cards have a radio frequency identification (RFID) device, and wherein electronically sensing the identities of cards comprises sensing the identities of cards with a RFID reader.

4. The method of claim 1 wherein electronically sensing the identities of cards comprises sensing images on the cards and mapping the images to the cards' identities.

5. The method of claim 1 wherein the cards have an electronic circuit, and wherein electronically sensing the identities of cards comprises sensing a signal from the electronic circuit.

6. The method of claim 1 further comprising:
players making bets during the game using physical chips representing values; and
electronically sensing the values of bets made during the game.

7. The method of claim 6 wherein the chips have a barcode printed thereon, and wherein electronically sensing the values of chips comprises sensing the values of chips with a barcode scanner.

8. The method of claim 6 wherein the chips have a radio frequency identification (RFID) device, and wherein electronically sensing the values of bets comprises sensing the values of chips with a RFID reader.

9. The method of claim 6 wherein electronically sensing the values of bets comprises sensing images on the chips and mapping the images to the chips' values.

10. The method of claim 6 wherein the chips have an electronic circuit, and wherein electronically sensing the values of bets comprises sensing a signal from the electronic circuit.

11. The method of claim 6 wherein chips of different values have different weights, and wherein electronically sensing the values of bets comprises generating a signal relating to a bet chip's weight and converting the sensed weight into a value.

12. The method of claim 1 wherein electronically communicating to the first player the identities of the cards dealt to the first player and electronically communicating to the first player any bets made during the game comprises:
electronically communicating to the first player the identities of the cards dealt to the first player via a communications network; and
electronically communicating to the first player any bets made during the game via the communications network.

13. The method of claim 1 wherein receiving commands from the first player regarding playing the game comprises receiving commands from a player input device or a player's voice via a communications network.

14. The method of claim 13 wherein the player input device comprises a keyboard, a mouse, or a touch screen.

15. The method of claim 1 further comprising viewing the playing area with a video camera.

16. The method of claim 1 further comprising at least one player physically at the playing area playing the game with at least the first player.

17. The method of claim 1 further comprising multiple players playing the game remotely by receiving signals identifying sensed cards and bets made during the game.

18. A system for conducting a table game comprising:
a playing area for carrying out a game;
at least a first player position at the playing area for a remote player communicating via an electronic communications network, the playing area having multiple player positions for accommodating multiple players;
a sensor for electronically sensing the identities of physical cards dealt to at least the first player;
a communications circuit for electronically communicating to the first player the identities of the cards dealt to the first player, any bets made during the game, and an outcome of the game; and
a receiver circuit for receiving commands from the first player regarding playing the game.

19. The system of claim 18 wherein the sensor comprises a barcode reader, a radio frequency identification (RFID) device reader, or an image sensor.

20. The system of claim 18 wherein the sensor is also for electronically sensing physical chips bet at the playing area.

21. The method of claim 20 wherein the sensor comprises a barcode reader, a radio frequency identification (RFID) device reader, an image sensor, or a scale for converting a weight of bet chips into electronic signals.
